(19) United States
(12) Patent Application Publication
(10) Pub. No.: US 2010/0104774 A1
(43) Pub. Date: Apr. 29, 2010

(54) DOUBLE-SIDED PRESSURE-SENSITIVE ADHESIVE TAPES FOR PRODUCING LC DISPLAYS HAVING LIGHT-REFLECTING AND ABSORBING PROPERTIES

(75) Inventors: Marc Husemann, Hamburg (DE); Reinhard Storbeck, Hamburg (DE)

Correspondence Address: Briscoe, Kurt G.;Norris McLaughlin & Marcus, PA, 875 Third Avenue, 8th Floor, New York, NY, 10022, US

(73) Assignee: TESA AG, Hamburg (DE)

(21) Appl. No.: 11/996,143

(22) PCT Filed: Dec. 2, 2005
(86) PCT No.: PCT/EP05/56415

§ 371 Date: May 5, 2008

(30) Foreign Application Priority Data
Jul. 21, 2005 (DE) 10 2005 034 747.9

(51) Int. Cl. C09K 19/02; C09J 5/00; B32B 7/12

(52) U.S. Cl. 428/1.5; 156/306.6; 428/354

(57) ABSTRACT

Pressure-sensitive adhesive (PSA) tape, intended in particular for producing or bonding optical liquid-crystal data displays (LCDs), having a carrier sheet and two PSA layers, the carrier sheet having translucent properties and there being a metallic layer and a white-coloured layer between the carrier sheet and at least one of the PSA layers.

The invention relates to double-sided pressure-sensitive adhesive tapes having multilayer carrier constructions and having light-reflecting and absorbing properties for producing liquid-crystal data displays (LCDs).

Pressure-sensitive adhesive tapes in the age of industrialization are widespread processing auxiliaries. Particularly for use in the computer industry, very exacting requirements are imposed on pressure-sensitive adhesive tapes. As well as having a low outgassing behavior, the pressure-sensitive adhesive tapes ought to be suitable for use across a wide temperature range and ought to fulfill certain optical properties. One field of use is that of LC displays, which are needed for computers, TVs, laptops, PDAs, cellphones, digital cameras, etc.

For the production of LC displays, LEDs (light-emitting diodes), as the light source, are bonded to the LCD glass. Frequently, black, double-sided pressure-sensitive adhesive tapes are used for this purpose. The aim of the black coloration is to prevent light penetrating from inside to outside and vice versa in the region of the double-sided pressure-sensitive adhesive tape.

There are already numerous approaches in existence for achieving such black coloring. On the other hand, there is a desire to increase the light efficiency of the back light module, and so it is preferred to use double-sided adhesive tapes which are black (light-absorbing) on one side and light-reflecting on the other side.

For the production of the black side there are likewise numerous approaches in existence.

One approach to the production of black double-sided pressure-sensitive adhesive tapes lies in the coloration of the carrier material. Within the electronics industry great preference is attached to using double-sided pressure-sensitive adhesive tapes having polyester film carriers (PET), on account of their very good diecutability. The PET carriers can be colored with carbon black or other black pigments for example, in order to achieve light absorption. The disadvantage of this existing approach is the low level of light absorption. In very thin carrier layers it is possible to incorporate only a relatively small number of particles of carbon black or other black pigment, with the consequence that absorption of the light is incomplete. With the eye, and also with relatively intensive light sources (with a luminance of greater than 600 candelas), it is then possible to determine the deficient absorption.

Another approach to producing black double-sided pressure-sensitive adhesive tapes concerns the production of a two-layer carrier material by means of coextrusion. Carrier films are generally produced by extrusion. As a result of the coextrusion, as well as the conventional carrier material, a second, black layer is coextruded, fulfilling the function of light absorption. This approach too has a variety of disadvantages. For example, for extrusion it is necessary to use antiblocking agents, which then lead to what are called pinholes in the product. These pinholes are optical point defects (light passes through these holes) and adversely impact the functioning in the LCD.

A further problem is posed by the layer thicknesses, since the two layers are first of all shaped individually in the die and it is therefore possible overall to realize only relatively thick carrier layers, with the result that the film becomes relatively thick and inflexible and hence its conformation to the surfaces to be bonded is poor. Moreover, the black layer must likewise be relatively thick, since otherwise it is not possible to realize complete absorption. A further disadvantage lies in the altered mechanical properties of the carrier material, since the mechanical properties of the black layer are different from those of the original carrier material (e.g., pure PET). A further disadvantage of the two-layer version of the carrier material is the difference in anchoring of the adhesive to the coextruded carrier material. In this specific embodiment, there is always a weak point in the double-sided adhesive tape.

In a further approach, a black colored coating layer is coated onto the carrier material. This coating may take place single-sidedly or double-sidedly on the carrier. This approach too has a variety of disadvantages. On the one hand, here as well, defects (pinholes) are readily formed, and are introduced by antiblocking agents during the film extrusion operation. These pinholes are unacceptable for final application in the LC display. Furthermore, the maximum absorption properties do not correspond to the requirements, since it is possible to apply only relatively thin coating layers. Here there is also an upper limit on the layer thicknesses, since otherwise the mechanical properties of the carrier material would suffer alteration.

In the development of LC displays there is a trend developing. On the one hand, the LC displays are to become more lightweight and flatter, and there is a rising demand for ever larger displays with ever higher resolution.

For this reason, the design of the displays has been changed, and the light source, accordingly, is coming nearer and nearer to the LCD panel, with the consequence of an increasing risk of more and more light penetrating outwards into the marginal zone (“blind area”) of the LCD panel (cf. FIG. 1). With this development, therefore, there is also an increase in the requirements imposed on the shading properties (blackout properties) of the double-sided adhesive tape, and there is a need for new approaches to the production of black adhesive tapes.

On the other hand, the double-sided adhesive tape ought to be reflecting. Known for this purpose are double-sided pressure-sensitive adhesive tapes which possess on one side a white or a metallic layer and on the other side a black light-absorbing layer.

This approach, however, also has disadvantages, since—if the angle of view into the LCD display amounts to approximately 45°—instances of light scattering are perceived, which come about as a result of the strong reflection of the light. In order to avoid this—but nevertheless to increase the light yield—a gray reflecting layer is needed.

Certain approaches to the production of gray adhesive tapes are likewise known in the literature.

Hence, for example, the most simple process is to admix gray color particles to the adhesive or to give one side of the carrier a gray coating. These methods, however, are relatively costly and inconvenient, since it is difficult to hit the correct shade via the appropriate color particle composition.

It is an object of the invention, therefore, to provide a double-sided pressure-sensitive adhesive tape which eschews the aforementioned processes and is capable of absorbing light completely and of allowing reflection of light by means of a gray color side.

In the context of this invention it has surprisingly been found that this can be achieved outstandingly through the degree of filling of the carrier film with white color particles, in combination with a metalized and white-coated back side.

The present invention accordingly relates in one embodiment to a pressure-sensitive adhesive tape, in particular for the production or adhesive bonding of optical liquid-crystal data displays (LCDs), having a carrier film and two pressure-sensitive adhesive layers, the carrier film having translucent properties, and there being a metallic layer and a white-colored layer provided between the carrier film and at least one of the pressure-sensitive adhesive layers.

By translucency or else translucent properties is meant the property of allowing light to pass through (in comparison to transparency, which describes the see-through state). Translucent bodies appear hazy, but may appear clear in contact with a substrate (contact clarity).

For the purposes of this invention the carrier films are termed translucent more particularly when they have a transmittance as measured by method A in the range between a minimum of 5% and a maximum of 95%, more particularly between 50% and 70%.

In another embodiment, the present invention relates to double-sided pressure-sensitive adhesive tapes which are composed of a single-layer or multilayer carrier material and of two identical or different pressure-sensitive adhesives (PSAs).

### BRIEF DESCRIPTION OF THE DRAWINGS

The invention will now be described in greater detail with reference to the drawings, wherein:

FIG. 1 shows the approach for a double-sided adhesive tape having a gray layer for absorption and a layer for reflection, in accordance with the prior art; the key to the reference numerals is as follows:

1 LCD glass 8 reflective film

2 double-sided gray-white adhesive tape 9 LCD casing

3 pressure-sensitive adhesive 10 gray absorbing side of adhesive tape

4 light source (LED) 11 white reflecting side

5 light beams 12 visible region

6 double-sided adhesive tape 13 “blind” region

7 optical waveguide

FIG. 2 is a schematic showing the construction of one embodiment of the adhesive tape according to the present invention.

FIG. 3 is a schematic showing the construction of another embodiment of the adhesive tape according to the present invention.

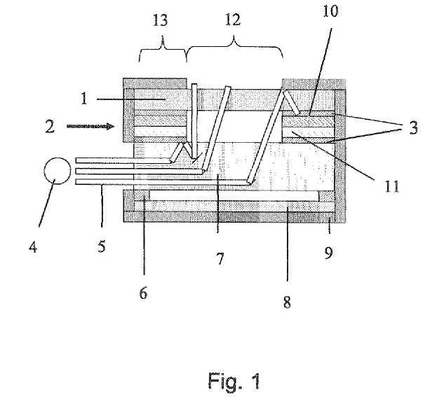

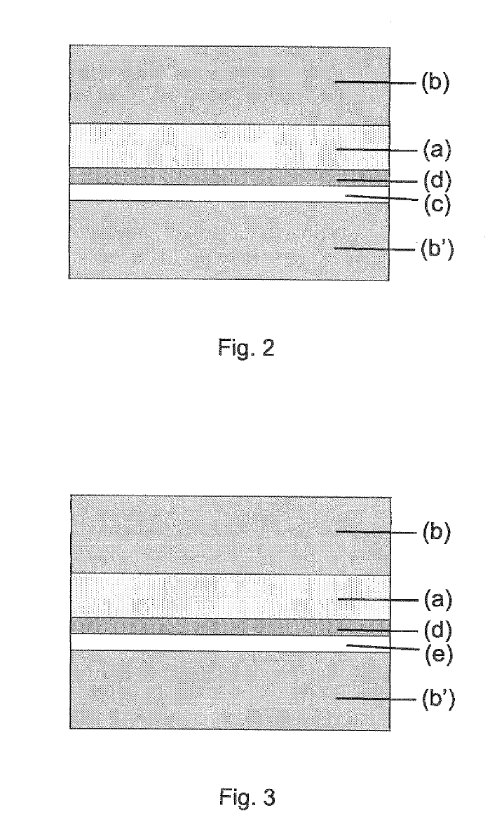

In one particularly advantageous embodiment in accordance with FIG. 2 the pressure-sensitive adhesive tape of the invention is composed of a translucent carrier film layer (a) filled with white color pigments, the translucency being variable through the degree of filling with white pigments, a white coating layer (c), a metallic layer (d), and two pressure-sensitive adhesive layers (b) and (b′), it being possible for the PSAs to be identical or to differ from one another.

In a further preferred embodiment of the invention the pressure-sensitive adhesive tape of the invention possesses the product construction depicted in FIG. 3, in which the pressure-sensitive adhesive tape is composed of a translucent carrier film layer filled with white color pigments—of variably adjustable translucency as above—a white primer layer (e), a metallic layer (d), and two pressure-sensitive adhesive layers (b) and (b'), it being possible for the PSAs, again, to be identical or to differ from one another.

The invention is elucidated more closely below:

The carrier film (a) is preferably between 5 and 250 μm, more preferably between 8 and 50 μm, most preferably between 12 and 36 μm thick. The degree of filling of white pigments can be chosen variably, so that different degrees of translucency result and the carrier film appears in different gray shades as a result of the differing extent of white coloration.

The layer (e) is a white primer layer. The layer thickness is advantageously between 1 and 15 μm: preferably between 3 and 10 μm.

The PSA layers (b) and (b′) preferably possess a thickness of in each case 5 μm to 250 μm, independently of one another. The layers may also be configured with the same thickness.

The thickness of the layer (d) is preferably between 0.01 μm and 5 μm. In a particularly preferred procedure, aluminum or silver is applied to the carrier film (a) by vapor coating in order to generate the metallic layer.

The coating layers (c) are light-reflecting and at the same time light-absorbing and white. The thickness of the layer (c) is preferably between 1 μm and 15 μm. Within the meaning of layer (c) it is also possible for there to be two or more coating layers provided, lying one atop another.

The individual layers (b), (b′), (c), (d), and (e) within the double-sided pressure-sensitive adhesive tape may be configured differently in terms of the layer thickness, but advantageously it is also possible for some or all of these layers to be present with the same thickness. Thus, for example, PSA layers (b) and (b′) of different thicknesses or the same thickness can be applied.

Carrier Film (a)

As film carriers it is possible in principle to use all filmlike polymer carriers which possess light translucency and can be colored white (during and/or after their production). Thus, for example, it is possible to use polyethylene, polypropylene, polyimide, polyester, polyamide, polymethacrylate, etc. One particularly preferred procedure uses polyester films, very preferably PET films (polyethylene terephthalate). The films may have been detensioned or may have one or more preferential directions. Preferential directions are obtained by drawing in one or in two directions.

Moreover, PET films up to 12 μm thick, more especially exactly 12 μm thick are very preferred; these films allow very good adhesive properties for the double-sided adhesive tape, since in this case the film is very flexible and is able to conform well to the surface roughnesses of the substrates that are to be bonded. Moreover, coloring the PET places the translucency within a balanced framework, which is very advantageous for the function utilized for the invention. To improve the anchorage it is very advantageous if the films are pretreated. The films, for example, may have been etched (e.g., trichloroacetic acid or trifluoroacetic acid), may have been corona- or plasma-pretreated, or may have been furnished with a primer (e.g., Saran).

The film additionally comprises white color pigments or white chromophoric particles. The particles or pigments that are familiar to the skilled worker are suitable. Examples include all customary titanium dioxide particles or barium sulfate particles for white coloration. The pigments or particles ought, however, always to be smaller in diameter than the final layer thickness of the carrier film. The degree of white coloration is controlled by the layer thickness of the film and by the transmittance. The light transmittance of the white film ought preferably to be at minimum 50% and at maximum 95%, in order to achieve subsequent gray coloration of the side. The optimum degree of filling with white color particles is dependent on the chemical composition and on the overall layer thickness of the film. Optimum colorations can be achieved with 2% to 20% by weight particle fractions, based on the film material.

Primer Layer (e)

The primer layer (e) fulfills a variety of functions. One function is the additional absorption of external light. In one advantageous embodiment of the invention, therefore, one which particularly utilizes this function, for the double-sided pressure-sensitive adhesive tape the transmittance in a wavelength range of 300-800 nm ought to be situated at <0.5%, more preferably at <0.1%, most preferably at <0.01%.

In a further function the primer layer (e) fulfils the light reflection. The light reflection according to test method c ought preferably to be greater than 65%. In a further function the primer layer (e) improves the anchorage of the PSA (b) and/or (b′) to the carrier film (a).

In one very preferred version, in accordance with the invention, a white primer layer is employed.

Primers can be coated as 100% systems, from solution or from dispersion. Generally speaking, primers are composed of an adhesion-promoting matrix, which with particular preference is blended with a reactive component. For the purposes of this invention, white color pigments or white chromophoric substances have been admixed to the primer. As adhesion-promoting matrix it is possible for example to use polyesters, polyurethanes, polyacrylates, silicones, and polymethacrylates. As a reactive component it is possible for example to use difunctional or polyfunctional isocyanates, difunctional or polyfunctional aziridines, difunctional or polyfunctional hydrazines, difunctional or polyfunctional oxazolidines, and polyfunctional aromatic dicarboxylic anhydrides. The reactive components are chosen in such a way that a reaction can take place with the PSA (b) and (b′). Examples of polyfunctional aziridines are Crosslinker CX100™ from ICI, XAMA™ 7, XAMA™ 2, and XAMA™ 22Q from Ichemco, and, for polyfunctional isocyanates, the Desmodur series from Lanxess, and also Curing Agent W, W3, WS5, D, 100D, and RF-AE from Ichemco. Difunctional or polyfunctional oxazolidines are available commercially under the trade name EPOROS from Nippon Shokubai; similarly, hydrazines and aromatic dicarboxylic anhydrides.

For the dilution of the difunctional or polyfunctional reactive components it is preferred to use, for example, aqueous polyacrylate dispersion, such as Neocryl A4S™ from Zeneca, or SK 1800 from Nippon Shokubai, for example.

The dispersion binds in the reactive primer and therefore facilitates the operation of the coating of the substrate as coating or by means of the transfer technique. For primer dispersions in particular it can be advantageous if further additives are used, for the purpose for example of improving the coatability, by reducing the foaming, or adjuvants for improving the stability of the keeping properties of dispersions. Here it is possible to have recourse to the additives that are known for this purpose to the skilled worker.

For the dilution of the difunctional or polyfunctional reactive components, in a further advantageous version, use is made of solvent-based adhesion-promoting matrices. Commercial examples of such include Unisol 11 primer from Ichemco, or NX 350 and NX 380 from Nippon Shokubai, for example.

In one very preferred embodiment of the invention titanium dioxide or barium sulfate is admixed as chromophoric particles to the adhesion-promoting component and/or to the reactive component. At a very high level of additization (more particularly >20% by weight), this additization not only has the function of complete light absorption but also effects light reflection. For the optimum coloring of the primer layer (e) the particle size distribution of the white color pigments is very important. Hence the particles ought at least to be smaller than the total thickness of the primer layer (e). Preference is given to using particles having an average diameter of 50 nm to 5 μm, more preferably between 100 nm and 3 μm, most preferably between 200 nm and 1 μm. Size grades of this kind can be obtained, for example, by controlled milling in boremills, with subsequent controlled screening. For the quality of the coloration, furthermore, homogeneous distribution of the color particles in the primer matrix is very advantageous. For this purpose it is preferred to use an intense mixing operation, which in one optimum procedure entails mixing by means of an Ultraturrax (high-performance homogenizer). With this step it is then possible to break down the color particles again and homogenize them in the primer matrix.

Coating Layer (c)

The coating layer (c) fulfills a variety of functions. One function of the color layer is the additional adsorption of external light. In one advantageous embodiment of the invention, therefore, which makes particular use of this function, for the double-sided pressure-sensitive adhesive tape the transmittance in a wavelength range of 300 to 800 nm ought to be situated at <0.5%, more preferably at <0.1%, most preferably at <0.01%.

The coating layer (c) further fulfills the function of light reflection. The light reflection according to test method c ought preferably to be greater than 65%. Very preferably this is achieved using a white coating layer.

Coating materials can be coated as 100% systems, from solution or from dispersion.

Coating materials are composed of a curing binder matrix (preferably a thermosetting system, or alternatively radiation-curing system) and white color pigments and are then applied using a printing unit (by flexographic printing, for example). In order to achieve sufficient opacity, application may also take place in two or more steps, so that two or more layers of printing ink are applied. Moreover, the ink can also be applied using an engraved-roll applicator unit. In this way it is possible to apply relatively high ink layer thicknesses in one step.

The coating materials may be based, for example, on polyesters, polyurethanes, polyacrylates and/or polymethacrylates. Additionally it is possible for further, known coatings additives to have been added. The coating material preferably further includes a crosslinking component, which more particularly serves for curing. It can be activated either by radiation curing (electron beam curing, by means for example of difunctional or polyfunctional vinylic compounds; UV curing, either for example by means of UV photocation generators, more particularly in conjunction with difunctional or polyfunctional epoxides, or by means of UV free-radical initiators of Norrish I or Norrish II type, more particularly in conjunction with difunctional or polyfunctional vinylic compounds, such as acrylates or methacrylates, for example) or by means of thermally activable compounds, such as difunctional or polyfunctional isocyanates, difunctional or polyfunctional epoxides, and/or difunctional or polyfunctional hydroxides, in accordance with dependence on the base matrix of the coating material.

In one inventive procedure which is very much to be preferred, chromophoric particles mixed into the coating material that forms the coating layer are titanium dioxide or barium sulfate. At a very high level of additization (more particularly >20% by weight), this additization not only produces the function of complete light absorption but also effects light reflection. For the optimum coloring of the coating layer (c) the particle size distribution of the white color pigments is very important. Thus the particles ought at least to be smaller than the total thickness of the coating layer (c). Preference is given to using particles having an average diameter of 50 nm to 5 μm, more preferably between 100 nm and 3 μm, most preferably between 200 nm and 1 μm. On the acquisition of size grades of this kind, see earlier on above.

Metallic Layer (d)

For the production of a side which in particular is a high-reflectivity and light-absorbing side, a silver-colored coating material can be applied to the film layer (a) and/or the film layer (a) can be vapor-coated on one or both sides with a metal, aluminum or silver for example. For the version involving silver-colored coating material, a binder matrix is blended with silver color pigments. Examples of suitable binder matrices include polyurethanes or polyesters which have a high refractive index and a high transparency. Alternatively the color pigments can be bound up into a polyacrylate or polymethacrylate matrix and then cured in the form of coating material.

In one preferred embodiment the film layer (a) is vapor-coated on both sides with aluminum or silver. In order to achieve particularly outstanding reflecting properties, the scattering operation for vapor coating ought to be controlled in such a way that the aluminum or silver is applied very uniformly, in order to obtain optimum reflection (avoidance of scattering effects). Furthermore, in one very preferred embodiment, the PET film is pretreated by plasma or corona before being vapor-coated with aluminum or silver. Through the use of the reflecting layer (b), on the one hand the light is reflected in a targeted way, and on the other hand the transmission of the light through the carrier material is reduced or avoided. Furthermore, surface roughnesses on the part of the carrier film are compensated.

Pressure-Sensitive Adhesives (PSAs) (b) and (b′)

In one preferred embodiment the PSAs (b) and (b′) are identical on both sides of the pressure-sensitive adhesive tape. In one specific embodiment, however, it may also be of advantage for the PSAs (b) and (b′) to differ from one another, in particular in their layer thickness and/or in their chemical composition. Thus in this way it is possible, for example, to set different pressure-sensitive adhesion properties. PSA systems employed for the inventive double-sided pressure-sensitive adhesive tape are preferably acrylate adhesives, natural rubber adhesives, synthetic rubber adhesives, silicone adhesives or EVA adhesives. PSA preferably has a high transparency or is colored white if appropriate.

Moreover, it is possible to use the further PSAs that are known to the skilled worker as are given for example in the “Handbook of Pressure Sensitive Adhesive Technology” by Donatas Satas (van Nostrand, New York 1989).

For natural rubber adhesives the natural rubber is milled preferably to a molecular weight (weight average) of not below about 100 000 daltons, more preferably not below 500 000 daltons, and additized.

In the case of rubber/synthetic rubber as starting material for the adhesive, there are wide possibilities for variation. Use may be made of natural rubbers or of synthetic rubbers, or of any desired blends of natural rubbers and/or synthetic rubbers, it being possible for the natural rubber or natural rubbers to be chosen in principle from all available grades, such as, for example, crepe, RSS, ADS, TSR or CV grades, in accordance with the purity level and viscosity level required, and for the synthetic rubber or synthetic rubbers to be chosen from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

With further preference it is possible, in order to improve the processing properties of the rubbers, to add to them thermoplastic elastomers with a weight fraction of 10% to 50% by weight, based on the overall elastomer fraction. As representatives, mention may be made at this point, in particular, of the particularly compatible styrene-isoprene-styrene (SIS) and styrene-butadiene-styrene (SBS) types.

In one inventively preferred embodiment use is made of (meth)acrylate PSAs.

Inventively employed (meth)acrylate PSAs, which are obtainable by free-radical addition polymerization, preferably consist to the extent of at least 50% by weight of at least one acrylic monomer from the group of the compounds of the following general formula:

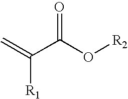

In this formula R₁ is H or CH₃; the radical R₂ is H or CH₃ or is selected from the group of branched or unbranched, saturated alkyl groups having 1-30 carbon atoms.

The monomers are preferably chosen such that the resulting polymers can be used, at room temperature or higher temperatures, as PSAs, more particularly such that the resulting polymers possess pressure-sensitive adhesive properties in accordance with the “Handbook of Pressure Sensitive Adhesive Technology” by Donatas Satas (van Nostrand, New York 1989).

In a further inventive embodiment the comonomer composition is chosen such that the PSAs can be used as heat-activable PSAs. The polymers can be obtained preferably by polymerizing a monomer mixture which is composed of acrylic esters and/or methacrylic esters and/or the free acids thereof, with the formula CH₂═CH(R₁)(COOR₂), where R₁═H or CH₃ and R₂ is an alkyl chain having 1-20 C atoms or is H. The molar masses M_{w} (weight average) of the polyacrylates used amount preferably to M_{w}≧200 000 g/mol.

In one way which is greatly preferred, acrylic or methacrylic monomers are used which are composed of acrylic and methacrylic esters having alkyl groups comprising 4 to 14 C atoms, and preferably comprise 4 to 9 C atoms. Specific examples, without wishing to be restricted by this enumeration, are methacrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and the branched isomers thereof, such as isobutyl acrylate, 2-ethyl-hexyl acrylate, 2-ethylhexyl methacrylate, isooctyl acrylate, and isooctyl methacrylate, for example.

Further classes of compound which can be used are monofunctional acrylates and/or methacrylates of bridged cycloalkyl alcohols consisting of at least 6 C atoms. The cycloalkyl alcohols can also be substituted, by C-1-6 alkyl groups, halogen atoms or cyano groups, for example. Specific examples are cyclohexyl methacrylates, isobornyl acrylate, isobornyl methacrylates, and 3,5-dimethyladamantyl acrylate.

In an advantageous procedure monomers are used which carry polar groups such as carboxyl radicals, sulfonic and phosphonic acid, hydroxyl radicals, lactam and lactone, N-substituted amide, N-substituted amine, carbamate, epoxy, thiol, alkoxy or cyano radicals, ethers or the like.

Moderate basic monomers are, for example, N,N-dialkyl-substituted amides, such as, for example, N,N-dimethylacrylamide, N,N-dimethylmethacrylamide, N-tert-butylacrylamide, N-vinylpyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(butoxymethyl)methacrylamide, N-methylolacrylamide, N-(ethoxymethyl)acrylamide, N-isopropylacrylamide, this enumeration not being exhaustive.

Further preferred examples are hydroxyethyl acrylate, hydroxypropyl acrylate, hydroxyethyl methacrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, and dimethylacrylic acid, this enumeration not being exhaustive.

In one further very preferred procedure use is made as monomers of vinyl esters, vinyl ethers, vinyl halides, vinylidene halides, and vinyl compounds having aromatic rings and heterocycles in α-position. Here again, mention may be made, nonexclusively, of some examples: vinyl acetate, vinylformamide, vinylpyridine, ethyl vinyl ether, vinyl chloride, vinylidene chloride, and acrylonitrile.

Moreover, in an advantageous procedure, use is made of photoinitiators having a copolymerizable double bond. Suitable photoinitiators include Norrish I and II photoinitiators. Examples include benzoin acrylate and an acrylated benzophenone from UCB (Ebecryl P 36®). In principle it is possible to copolymerize any photoinitiators which are known to the skilled worker and which are able to crosslink the polymer by way of a free-radical mechanism under UV irradiation. An overview of possible photoinitiators which can be used and can be functionalized by a double bond is given in Fouassier: “Photoinitiation, Photopolymerization and Photocuring: Fundamentals and Applications”, Hanser-Verlag, Munich 1995. Carroy et al. in “Chemistry and Technology of UV and EB Formulation for Coatings, Inks and Paints”, Oldring (Ed.), 1994, SITA, London is used as a supplement.

In another preferred procedure the comonomers described are admixed with monomers which possess a high static glass transition temperature. Suitable components include aromatic vinyl compounds, an example being styrene, in which the aromatic nuclei consist preferably of C₄ to C₁₈ units and may also include heteroatoms. Particularly preferred examples are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenylyl acrylate, 4-biphenylyl methacrylate, 2-naphthyl acrylate, 2-naphthyl methacrylate, and mixtures of these monomers, this enumeration not being exhaustive.

As a result of the increase in the aromatic fraction there is a rise in the refractive index of the PSA, and the scattering between LCD glass and PSA as a result, for example, of extraneous light is minimized.

For further development it is possible to admix resins to the PSAs. As tackifying resins for addition it is possible to use the tackifier resins previously known, and described in the literature. Representatives that may be mentioned include pinene resins, indene resins and rosins, their disproportionated, hydrogenated, polymerized, and esterified derivatives and salts, the aliphatic and aromatic hydrocarbon resins, terpene resins and terpene-phenolic resins, and also C5, C9, and other hydrocarbon resins. Any desired combinations of these and further resins may be used in order to adjust the properties of the resultant adhesive in accordance with requirements. Generally speaking it is possible to employ any resins which are compatible (soluble) with the polyacrylate in question: in particular, reference may be made to all aliphatic, aromatic and alkylaromatic hydrocarbon resins, hydrocarbon resins based on single monomers, hydrogenated hydrocarbon resins, functional hydrocarbon resins, and natural resins. Reference is expressly made to the presentation of the state of knowledge in the “Handbook of Pressure Sensitive Adhesive Technology” by Donatas Satas (van Nostrand, 1989).

Here as well, the transparency is improved using, preferably, transparent resins which are highly compatible with the polymer. Hydrogenated or partly hydrogenated resins frequently feature these properties.

In addition it is possible optionally for plasticizers, further fillers (such as, for example, fibers, carbon black, zinc oxide, chalk, solid or hollow glass beads, microbeads made of other materials, silica, silicates), nucleators, electrically conductive materials, such as, for example, conjugated polymers, doped conjugated polymers, metal pigments, metal particles, metal salts, graphite, etc., expandants, compounding agents and/or aging inhibitors, in the form of, for example, primary and secondary antioxidants or in the form of light stabilizers, to have been added.

In a further advantageous variant of the invention, the PSA (b′) comprises light-reflecting particles, such as white color pigments (titanium dioxide or barium sulfate) as filler, for example.

In addition it is possible to admix crosslinkers and promoters for crosslinking. Examples of suitable crosslinkers for electron beam crosslinking and UV crosslinking include difunctional or polyfunctional acrylates, difunctional or polyfunctional isocyanates (including those in blocked form), and difunctional or polyfunctional epoxides. In addition it is also possible for thermally activable crosslinkers to have been added, such as Lewis acid, metal chelates or polyfunctional isocyanates, for example.

For optional crosslinking with UV light it is possible to add UV-absorbing photoinitiators to the PSAs. Useful photoinitiators whose use is very effective are benzoin ethers, such as benzoin methyl ether and benzoin isopropyl ether, substituted acetophenones, such as 2,2-diethoxyacetophenone (available as Irgacure 651® from Ciba Geige), 2,2-dimethoxy-2-phenyl-1-phenylethanone, dimethoxyhydroxyacetophenone, substituted α-ketols, such as 2-methoxy-2-hydroxypropiophenone, aromatic sulfonyl chlorides, such as 2-naphthylsulfonyl chloride, and photoactive oximes, such as 1-phenyl-1,2-propanedione 2-(O-ethoxycarbonyl)oxime, for example.

The abovementioned photoinitiators and others which can be used, and also others of the Norrish I or Norrish II type, can contain the following radicals: benzophenone, acetophenone, benzil, benzoin, hydroxyalkylphenone, phenyl cyclohexyl ketone, anthraquinone, trimethylbenzoylphosphine oxide, methylthiophenylmorpholine ketone, aminoketone, azobenzoin, thioxanthone, hexarylbisimidazole, triazine, or fluorenone, it being possible for each of these radicals to be additionally substituted by one or more halogen atoms and/or by one or more alkyloxy groups and/or by one or more amino groups or hydroxy groups. A representative overview is given by Fouassier: “Photoinitiation, Photopolymerization and Photocuring: Fundamentals and Applications”, Hanser-Verlag, Munich 1995. Carroy et al. in “Chemistry and Technology of UV and EB Formulation for Coatings, Inks and Paints”, Oldring (Ed.), 1994, SITA, London can be used as a supplement.

Preparation Processes for the Acrylate PSAs

For the polymerization the monomers are advantageously chosen such that the resultant polymers can be used at room temperature or higher temperatures as PSAs, in particular such that the resulting polymers possess pressure-sensitive adhesive properties in accordance with the “Handbook of Pressure Sensitive Adhesive Technology” by Donatas Satas (van Nostrand, New York 1989).

In order to achieve a preferred polymer glass transition temperature T_{g} of ≦25° C. for PSAs it is very preferred, in accordance with the comments made above, to select the monomers in such a way, and choose the quantitative composition of the monomer mixture advantageously in such a way, as to result in the desired T_{g} for the polymer in accordance with an equation (E1) analogous to the Fox equation (El) (cf. T. G. Fox, Bull. Am. Phys. Soc. 1 (1956) 123).

$$\frac{1}{{T}_{g}} = {\sum }_{n} \frac{{w}_{n}}{{T}_{g , n}} \qquad ( E 1 )$$

In this equation, n represents the serial number of the monomers used, wₙ, the mass fraction of the respective monomer n (% by weight), and T_{g,n} the respective glass transition temperature of the homopolymer of the respective monomer n, in K.

For the preparation of the poly(meth)acrylate PSAs it is advantageous to carry out conventional free-radical polymerizations. For the polymerizations which proceed free-radically it is preferred to employ initiator systems which also contain further free-radical initiators for the polymerization, especially thermally decomposing, free-radical-forming azo or peroxo initiators. In principle, however, all customary initiators which are familiar to the skilled worker for acrylates are suitable. The production of C-centered radicals is described in Houben Weyl, Methoden der Organischen Chemie, Vol. E 19a, pp. 60-147. These methods are employed, preferentially, in analogy.

Examples of free-radical sources are peroxides, hydroperoxides, and azo compounds; some nonlimiting examples of typical free-radical initiators that may be mentioned here include potassium peroxodisulf ate, dibenzoyl peroxide, cumene hydroperoxide, cyclohexanone peroxide, di-t-butyl peroxide, azodiisobutyronitrile, cyclohexylsulfonyl acetyl peroxide, diisopropyl percarbonate, t-butyl peroctoate, and benzpinacol. In one very preferred version the free-radical initiator used is 1,1′-azobis(cyclohexane-carbonitrile) (Vazo 88™ from DuPont) or azodiisobutyronitrile (AIBN).

The average molecular weights M_{w} (weight average) of the PSAs formed in the free-radical polymerization are very preferably chosen such that they are situated within a range of 200 000 to 4 000 000 g/mol; specifically, PSAs are prepared which have average molecular weights M_{w} of 400 000 to 1 400 000 g/mol. The average molecular weight is determined by size exclusion chromatography (GPC) or matrix-assisted laser desorption/ionization mass spectrometry (MALDI-MS).

The polymerization may be conducted without solvent, in the presence of one or more organic solvents, in the presence of water, or in mixtures of organic solvents and water. The aim is to minimize the amount of solvent used. Suitable organic solvents are pure alkanes (e.g., pure hexane, heptane, octane, isooctane), aromatic hydrocarbons (e.g., pure benzene, toluene, xylene), esters (e.g., ethyl, propyl, butyl or hexyl acetate), halogenated hydrocarbons (e.g., pure chlorobenzene), alkanols (e.g., methanol, ethanol, ethylene glycol, ethylene glycol monomethyl ether), and ethers (e.g., diethyl ether, dibutyl ether) or mixtures thereof. A water-miscible or hydrophilic cosolvent may be added to the aqueous polymerization reactions in order to ensure that the reaction mixture is present in the form of a homogeneous phase during monomer conversion. Cosolvents which can be used with advantage for the present invention are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulfides, sulfoxides, sulfones, alcohol derivatives, hydroxy ether derivatives, amino alcohols, ketones and the like, and also derivatives and mixtures thereof.

The polymerization time—depending on conversion and temperature—is between 2 and 72 hours. The higher the reaction temperature which can be chosen, i.e., the higher the thermal stability of the reaction mixture, the shorter can be the chosen reaction time.

As regards initiation of the polymerization, the introduction of heat is essential for the thermally decomposing initiators. For these thermally decomposing initiators the polymerization can be initiated by heating to from 50 to 160° C., depending on initiator type.

For the preparation it can also be of advantage to polymerize the (meth)acrylate PSAs without solvent. A particularly suitable technique for use in this case is the prepolymerization technique. Polymerization is initiated with UV light but taken only to a low conversion of about 10-30%. The resulting polymer syrup can then be welded, for example, into films (in the simplest case, ice cubes) and then polymerized through to a high conversion in water. These pellets can subsequently be used as acrylate hot-melt adhesives, it being particularly preferred to use, for the melting operation, film materials which are compatible with the polyacrylate. For this preparation method as well it is possible to add the thermally conductive materials before or after the polymerization.

Another advantageous preparation process for the poly(meth)acrylate PSAs is that of anionic polymerization. In this case the reaction medium used preferably comprises inert solvents, such as aliphatic and cycloaliphatic hydrocarbons, for example, or else aromatic hydrocarbons.

The living polymer is in this case generally represented by the structure P_{L}(A)-Me, where Me is a metal from group I, such as lithium, sodium or potassium, and P_{L}(A) is a growing polymer from the acrylate monomers. The molar mass of the polymer under preparation is controlled by the ratio of initiator concentration to monomer concentration. Examples of suitable polymerization initiators include n-propyllithium, n-butyllithium, sec-butyllithium, 2-naphthyllithium, cyclohexyllithium, and octyllithium, though this enumeration makes no claim to completeness. Furthermore, initiators based on samarium complexes are known for the polymerization of acrylates (Macromolecules, 1995, 28, 7886) and can be used here.

It is also possible, furthermore, to employ difunctional initiators, such as 1,1,4,4-tetraphenyl-1,4-dilithiobutane or 1,1,4,4-tetraphenyl-1,4-dilithioisobutane, for example. Coinitiators can likewise be employed. Suitable coinitiators include lithium halides, alkali metal alkoxides, and alkylaluminum compounds. In one very preferred version the ligands and coinitiators are chosen so that acrylate monomers, such as n-butyl acrylate and 2-ethylhexyl acrylate, for example, can be polymerized directly and do not have to be generated in the polymer by transesterification with the corresponding alcohol.

Methods suitable for preparing poly(meth)acrylate PSAs with a narrow molecular weight distribution also include controlled free-radical polymerization methods. In that case it is preferred to use, for the polymerization, a control reagent of the general formula:

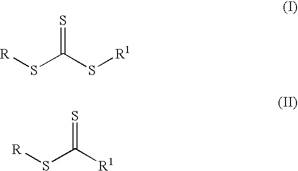

in which R and R¹ are chosen independently of one another or are identical, and represent
branched and unbranched C₁ to C₁₈ alkyl radicals; C₃ to C₁₈ alkenyl radicals; C₃ to C₁₈ alkynyl radicals;
C₁ to C₁₈ alkoxy radicals;
C₃ to C₁₈ alkynyl radicals; C₃ to C₁₈ alkenyl radicals; C₁ to C₁₈ alkyl radicals substituted by at least one OH group or a halogen atom or a silyl ether;
C₂-C₁₈ heteroalkyl radicals having at least one O atom and/or one NR* group in the carbon chain, R* being any radical (particularly an organic radical);
C₃-C₁₈ alkynyl radicals, C₃-C₁₈ alkenyl radicals, C₁-C₁₈ alkyl radicals substituted by at least one ester group, amine group, carbonate group, cyano group, isocyano group and/or epoxide group and/or by sulfur;
C₃-C₁₂ cycloalkyl radicals;
C₆-C₁₈ aryl or benzyl radicals;
hydrogen.

Control reagents of type (I) are preferably composed of the following compounds:

Halogen atoms therein are preferably F, CI, Br or I, more preferably Cl and Br. Outstandingly suitable alkyl, alkenyl and alkynyl radicals in the various substituents include both linear and branched chains.

Examples of alkyl radicals containing 1 to 18 carbon atoms are methyl, ethyl, propyl, isopropyl, butyl, isobutyl, t-butyl, pentyl, 2-pentyl, hexyl, heptyl, octyl, 2-ethylhexyl, t-octyl, nonyl, decyl, undecyl, tridecyl, tetradecyl, hexadecyl, and octadecyl.

Examples of alkenyl radicals having 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl, and oleyl.

Examples of alkynyl radicals having 3 to 18 carbon atoms are propynyl, 2-butynyl, 3-butynyl, n-2-octynyl, and n-2-octadecynyl.

Examples of hydroxy-substituted alkyl radicals are hydroxypropyl, hydroxybutyl, and hydroxyhexyl.

Examples of halogen-substituted alkyl radicals are dichlorobutyl, monobromobutyl, and trichlorohexyl.

An example of a suitable C₂-C₁₈ heteroalkyl radical having at least one oxygen atom in the carbon chain is —CH₂—CH₂—O—CH₂—CH₃.

Examples of C₃-C₁₂ cycloalkyl radicals include cyclopropyl, cyclopentyl, cyclohexyl, and trimethylcyclohexyl.

Examples of C₆-C₁₈ aryl radicals include phenyl, naphthyl, benzyl, 4-tert-butylbenzyl, and other substituted phenyls, such as ethyl phenyl, toluene, xylene, mesitylene, isopropylbenzene, dichlorobenzene or bromotoluene.

The above enumerations serve only as examples of the respective groups of compounds, and make no claim to completeness.

Other compounds which can also be used as control reagents include those of the following types:

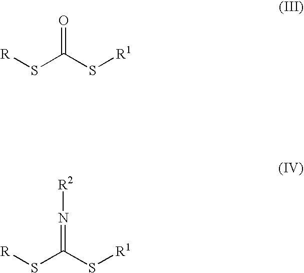

where R² likewise independently from R and R¹ may be selected from the group recited above for these radicals.

In the case of the conventional ‘RAFT’ process, polymerization is generally carried out only up to low conversions (WO 98/01478 A1) in order to produce very narrow molecular weight distributions. As a result of the low conversions, however, these polymers cannot be used as PSAs and in particular not as hot-melt PSAs, since the high fraction of residual monomers adversely affects the technical adhesive properties; the residual monomers contaminate the solvent recyclate in the concentration operation; and the corresponding self-adhesive tapes would exhibit very high outgassing behavior. In order to circumvent this disadvantage of low conversions, the polymerization in one particularly preferred procedure is initiated two or more times.

As a further controlled free-radical polymerization method it is possible to carry out nitroxide-controlled polymerizations. For free-radical stabilization, in a favorable procedure, use is made of nitroxides of type (Va) or (Vb):

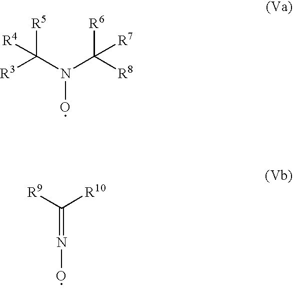

where R³, R⁴, R⁵, R⁶, R⁷, R⁸, R⁹, and R¹⁰ independently of one another denote the following compounds or atoms:
i) halides, such as chlorine, bromine or iodine, for example,
ii) linear, branched, cyclic, and heterocyclic hydrocarbons having 1 to 20 carbon atoms, which may be saturated, unsaturated or aromatic,
iii) esters —COOR¹¹, alkoxides —OR¹² and/or phosphonates —PO(OR¹³)₂, where R¹¹, R¹² or R¹³ stand for radicals from group ii).

Compounds of formulae (Va) or (Vb) can also be attached to polymer chains of any kind (primarily such that at least one of the abovementioned radicals constitutes a polymer chain of this kind) and may therefore be used for the synthesis of polyacrylate PSAs.

With greater preference, controlled regulators for the polymerization of compounds of the type are chosen:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethyl-piperidine-1-oxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-t-butyl nitroxide
diphenyl nitroxide
t-butyl t-amyl nitroxide.

A series of further polymerization methods in accordance with which the PSAs can be prepared by an alternative procedure can be chosen from the prior art: U.S. Pat. No. 4,581,429 A discloses a controlled-growth free-radical polymerization process which uses as its initiator a compound of the formula R′R″N—O—Y, in which Y is a free-radical species which is able to polymerize unsaturated monomers. In general, however, the reactions have low conversion rates. A particular problem is the polymerization of acrylates, which takes place only with very low yields and molar masses. WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process in which very specific free-radical compounds, such as phosphorus-containing nitroxides based on imidazolidine, for example, are employed. WO 98/44008 A1 discloses specific nitroxyls based on morpholines, piperazinones, and piperazinediones. DE 199 49 352 A1 describes heterocyclic alkoxyamines as regulators in controlled-growth free-radical polymerizations. Corresponding further developments of the alkoxyamines or of the corresponding free nitroxides improve the efficiency for the preparation of polyacrylates (Hawker, paper given to the National Meeting of the American Chemical Society, Spring 1997; Husemann, paper given to the IUPAC World-Polymer Meeting 1998, Gold Coast).

As a further controlled polymerization method, atom transfer radical polymerization (ATRP) can be used advantageously to synthesize the polyacrylate PSAs, in which case use is made preferably as initiator of monofunctional or difunctional secondary or tertiary halides and, for abstracting the halide(s), of complexes of Cu, Ni, Fe, Pd, Pt, Ru, Os, Rh, Co, Ir, Ag or Au (EP 0 824 111 A1; EP 826 698 A1; EP 824 110 A1; EP 841 346 A1; EP 850 957 A1). The various possibilities of ATRP are further described in the specifications U.S. Pat. No. 5,945,491 A, U.S. Pat. No. 5,854,364 A, and U.S. Pat. No. 5,789,487 A.

Coating Process, Treatment of the Carrier Material

For production, in one preferred procedure the PSA is coated from solution onto the carrier material. To increase the anchoring of the PSA it is possible optionally to pretreat the layers (a) and/or (b). Thus pretreatment may be carried out, for example, by corona or by plasma, a primer can be applied from the melt or from solution, or etching may take place chemically.

For the coating of the PSA from solution, heat is supplied, in a drying tunnel for example, to remove the solvent and, if appropriate, initiate the crosslinking reaction.

The polymers described above can also be coated, furthermore, as hotmelt systems (i.e., from the melt). For the production process it may therefore be necessary to remove the solvent from the PSA. In this case it is possible in principle to use any of the techniques known to the skilled worker. One very preferred technique is that of concentration using a single-screw or twin-screw extruder. The twin-screw extruder can be operated corotatingly or counterrotatingly. The solvent or water is preferably distilled off over two or more vacuum stages. Counterheating is also carried out depending on the distillation temperature of the solvent. The residual solvent fractions amount to preferably <1%, more preferably <0.5%, and very preferably <0.2%. Furthermore, it is also possible to utilize the twin-screw extruder in order to carry out compounding with the carbon black. In this way the carbon black can be distributed with very fine division in the pressure-sensitive adhesive matrix.

Very preferably the hotmelt is further-processed from the melt.

For coating as a hotmelt it is possible to employ different coating processes. In one version the PSAs are coated by a roll coating process. Different roll coating processes are described in the “Handbook of Pressure Sensitive Adhesive Technology”, by Donatas Satas (van Nostrand, New York 1989). In another version, coating takes place via a melt die. In a further preferred process, coating is carried out by extrusion. Extrusion coating is performed preferably using an extrusion die. The extrusion dies used may come advantageously from one of the three following categories: T-dies, fishtail dies and coathanger dies. The individual types differ in the design of their flow channels. Through the coating it is also possible for the PSAs to undergo orientation.

In addition it may be necessary for the PSA to be crosslinked. In one preferred version, crosslinking takes place with UV and/or electronic radiation.

UV crosslinking irradiation is carried out with shortwave ultraviolet irradiation in a wavelength range from 200 to 400 nm, depending on the UV photoinitiator used; in particular, irradiation is carried out using high-pressure or medium-pressure mercury lamps at an output of 80 to 240 W/cm. The irradiation intensity is adapted to the respective quantum yield of the UV photoinitiator and the degree of crosslinking that is to be set.

Furthermore, in one advantageous embodiment of the invention, the PSAs are crosslinked using electron beams. Typical irradiation equipment which are advantageously employed includes linear cathode systems, scanner systems, and segmented cathode systems, where electron beam accelerators are employed. A detailed description of the state of the art and the most important process parameters can be found in Skelhorne, Electron Beam Processing, in Chemistry and Technology of UV and EB formulation for Coatings, Inks and Paints, Vol. 1, 1991, SITA, London. The typical acceleration voltages are situated in the range between 50 kV and 500 kV, preferably between 80 kV and 300 kV. The scatter doses employed range between 5 to 150 kGy, in particular between 20 and 100 kGy.

It is also possible to employ both crosslinking processes, or other processes allowing high-energy irradiation.

The invention further provides for the use of the inventive double-sided pressure-sensitive adhesive tapes for the adhesive bonding or production of optical liquid-crystal data displays (LCDs), for the use of LCD glasses, and also liquid-crystal data displays and devices comprising liquid-crystal data displays which have a pressure-sensitive adhesive tape of the invention in their product's construction. For use as pressure-sensitive adhesive tape it is possible for the double-sided pressure-sensitive adhesive tapes to have been lined with one or two release films and/or release papers. Preference is given to using siliconized or fluorinated films or papers, such as glassine, HPDE or LDPE coated papers, for example, which have in turn been given a release coat based on silicones or fluorinated polymers. One particularly preferred embodiment uses siliconized PET films for lining.

The pressure-sensitive adhesive tapes of the invention are especially advantageous for adhesively bonding light-emitting diodes (LEDs), as the light source, to the LCD module.

### Examples

The invention is described below, without wishing any unnecessary restriction to result from the choice of the examples.

The following test methods were employed.

Test Methods

A. Transmittance

The transmittance was measured in the wavelength range from 190 to 900 nm using a Uvikon 923 from Biotek Kontron. Measurement is made at 23° C. The absolute transmittance is reported in % as the value at 550 nm, relative to complete light absorption (transmittance 0%=no light transmission; transmittance 100%=complete light transmission).

B. Pinholes

A commercially customary, very strong light source (e.g., Liesegangtrainer 400 KC type 649 overhead projector, 36 V halogen lamp, 400 W) is blacked out completely using a mask. This mask includes in its center a circular aperture having a diameter of 5 cm. It is over this circular aperture that the double-sided LCD adhesive tape is placed. In a completely darkened environment, the number of pinholes is then counted, either electronically or visually. With the light source switched on, these pinholes can be seen as translucent dots.

C. Reflection

The reflection test is carried out in accordance with DIN standard 5036 part 3, DIN 5033 part 3, and DIN 5033 part 4. The instrument used was a type LMT Ulbricht sphere (50 cm diameter), in conjunction with a type LMT Tau-ρ-Meter digital display device. The integral measurements are made using a light source corresponding to standard illuminant A and a V(λ)-adapted Si photoelement. Measurement was made against a glass reference sample. The reflectance is reported as the sum of directed and scattered light fractions in %.

Polymer 1

A 200 l reactor conventional for free-radical polymerizations was charged with 2400 g of acrylic acid, 64 kg of 2-ethylhexyl acrylate, 6.4 kg of N-isopropylacrylamide and 53.3 kg of acetone/isopropanol (95:5). After nitrogen gas had been passed through the reactor for 45 minutes with stirring, the reactor was heated to 58° C. and 40 g of 2,2′-azoisobutyronitrile (AIBN) were added. Subsequently the external heating bath was heated to 75° C. and the reaction was carried out constantly at this external temperature. After a reaction time of 1 h a further 40 g of AIBN were added. After 5 h and 10 h, dilution was carried out with 15 kg each time of acetone/isopropanol (95:5). After 6 h and 8 h, 100 g each time of dicyclohexyl peroxydicarbonate (Perkadox 16®, Akzo Nobel) in solution in each case in 800 g of acetone were added. The reaction was terminated after a reaction time of 24 h, and the reaction mixture cooled to room temperature. The solution is admixed with 0.3% by weight of aluminum chelate (3% strength solution in isopropanol) and immediately applied uniformly to a 50 μm siliconized PET liner. After drying at 120° C. for 10 minutes the coat weight was 50g/M².

Primer Composition 1

In a drum, 100 parts of Unisol 11 primer from Ichemco are mixed intensively with 10 parts of a polyfunctional isocyanate Curing Agent D (from Ichemco) and 25 parts of titanium dioxide (<5 μm, 99.9+, primarily rutile structure) for 1 h with a stirrer. Subsequently the mixture is homogenized further (for about 30 minutes) using an Ultraturrax. Primer composition 1 is used for coating immediately thereafter.

Coating Material 1

In a Red Devil paint mixer 42 parts of Acrydic A-910 (nitrogen-containing acrylic resin having a solids fraction of 50%, from Dainippon Ink and Chemicals), 80 parts of TitanWeiss [titanium white] JR603 (Teikoku Kako Co. Ltd.), 6 parts of xylene, 6 parts of toluene, and 6 parts of methyl ethyl ketone are dispersed for 30 minutes. Further homogenization then takes place in an Ultraturrax.

White Film Production:

Film a):

A polyethylene terephthalate copolymer was mixed with 10% by weight of titanium dioxide (average diameter 0.25 μm) in a compounder at 180° C. for 2 h and the mixture was dried under reduced pressure. Subsequently, in a single-screw extruder, the film material was extruded through a slot die (T-form, 300 μm slot) at 280° C. The film is applied to a mirror-coated chill roll. It is subsequently drawn 3.5-fold in the machine direction, by thermal conditioning at 90 to 95° C. The film is subsequently run into a tensioning device. There, using clamps, it is drawn 4-fold in the transverse direction at temperatures between 100° C. and 110° C. This is followed by further thermal conditioning at 210° C. for 10 s. The white PET film possesses an overall thickness of 36 μm.

In accordance with test method A, the film's transmittance is 55%.

Film b):

A polyethylene terephthalate copolymer was mixed with 5% by weight of titanium dioxide (average diameter 0.25 μm) in a compounder at 180° C. for 2 h and the mixture was dried under reduced pressure. Subsequently, in a single-screw extruder, the film material was extruded through a slot die (T-form, 300 μm slot) at 280° C. The film is applied to a mirror-coated chill roll. It is subsequently drawn 3.5-fold in the machine direction, by thermal conditioning at 90 to 95° C. The film is subsequently run into a tensioning device. There, using clamps, it is drawn 4-fold in the transverse direction at temperatures between 100° C. and 110° C. This is followed by further thermal conditioning at 210° C. for 10 s. The white PET film possesses an overall thickness of 36 μm.

In accordance with test method A, the film's transmittance is 70%.

Film (Al Vapor Coating):

The white PET films a) and b) are vapor-coated on one side with aluminum until a full-area aluminum layer had been applied [producing the aluminized films a*) from a) and b*) from b)]. The film was vapor-coated in a width of 300 mm by the sputtering process.

Here, positively charged, ionized argon gas is passed into a high-vacuum chamber. The charged ions then impinge on a negatively charged Al plate and, at the molecular level, detach particles of aluminum, which then deposit on the polyester film which is passed above the plate.

Film (Color Coating):

### Example 1

The single-sidedly aluminum-metalized film a*) is coated evenly on the Al side with the white primer composition 1 and is dried at 120° C. for 30 minutes. The side coated with the white primer is completely and uniformly white. The coat weight is approximately 10 g/m². Subsequently, in a laminating process, coating is carried out with the polymer 1 on both sides at 50 g/m².

### Example 2

The single-sidedly aluminum-metalized film b*) is coated evenly on the Al side with the white primer composition 1 and is dried at 120° C. for 30 minutes. The side coated with the white primer is completely and uniformly white. The coat weight is approximately 10 g/m². Subsequently, in a laminating process, coating is carried out with the polymer 1 on both sides at 50 g/m².

### Example 3

The single-sidedly aluminum-metalized film a*) is coated evenly on the Al side with the white coating material 1 and is dried at 120° C. for 30 minutes. The side coated with the white coating material is completely and uniformly white. The coat weight is approximately 10 g/m². Subsequently, in a laminating process, coating is carried out with the polymer 1 on both sides at 50 g/m².

### Example 4

The single-sidedly aluminum-metalized film b*) is coated evenly on the Al side with the white coating material 1 and is dried at 120° C. for 30 minutes. The side coated with the white coating material is completely and uniformly white. The coat weight is approximately 10 g/m². Subsequently, in a laminating process, coating is carried out with the polymer 1 on both sides at 50 g/m².

Results

Examples 1 to 4 were tested in accordance with test methods A, B, and C. Test method A provides information on the overall transmittance of the double-sided adhesive tape and hence data concerning the degree of light-absorption. Test method B determines whether the film contains optical defects. The reflectance (test C), in contrast, must not exceed levels of 65%, since otherwise the gray side is too strongly reflecting and would appear too white. The results for the inventive examples are shown in table 1.

| | Transmittance | Pinholes | Reflectance (total) |
|---|---|---|---|
| Example | (test A) | (test B) | (test C) |
| 1 | <0.1% | 0 | 56.3% |
| 2 | <0.1% | 0 | 58.6% |
| 3 | <0.1% | 0 | 50.1% |
| 4 | <0.1% | 0 | 51.5% |

From the results in table 1 it is apparent that examples 1 to 4 possess outstanding light absorption properties. Moreover, examples 1 to 4 demonstrate that the reflectance and hence the gradation of the white/metallic shading can be controlled through the filler content. The white film having the lowest filler content and the thinnest layer thickness reflects the least and possesses the grayest coloring. Examples 1 and 2, in contrast, demonstrate that film a*), with the highest white particle fraction, possesses the lowest gray coloration.

1. A pressure-sensitive adhesive tape, comprising a carrier film having translucent properties, two pressure-sensitive adhesive layers, and a metallic layer and a white-colored layer between the carrier film and at least one of the pressure-sensitive adhesive layers.

2. The pressure-sensitive adhesive tape of claim 1, wherein the translucent properties of the carrier film are effected by the presence of white pigments in the carrier film.

3. The pressure-sensitive adhesive tape of claim 1, wherein the carrier film has a light transmittance of 50% to 95%.

4. The pressure-sensitive adhesive tape of claim 1, wherein the white-colored layer is a primer layer.

5. The pressure-sensitive adhesive tape of claim 1, wherein the white-colored layer is a coating layer.

6. The pressure-sensitive adhesive tape of claim 1, wherein the metallic layer is disposed between the carrier film and the white-colored layer.

7. The pressure-sensitive adhesive tape of claim 1, wherein the pressure-sensitive adhesive layer on a side of the carrier film that faces away from the metallic layer is transparent.

8. A method for bonding a component of an optical liquid-crystal display, said method comprising adhering said component to a pressure-sensitive adhesive tape of claim 1.

9. Method of claim 8, wherein the component is a component of a LCD glass.

10. A liquid-crystal data display device comprising a pressure-sensitive adhesive tape of claim 1.
